(19) United States
(12) Patent Application Publication
(10) Pub. No.: US 2014/0137251 A1
(43) Pub. Date: May 15, 2014

(54) SYSTEM FOR IDENTIFYING MALICIOUS CODE OF HIGH RISK

(71) Applicant: KOREA INTERNET & SECURITY AGENCY, Seoul (KR)

(72) Inventors: Tai Jin LEE, Seoul (KR); Byung Ik KIM, Seoul (KR); Hong Koo KANG, Seoul (KR); Chang Yong LEE, Seoul (KR); Ji Sang KIM, Seoul (KR); Hyun Cheol JEONG, Seoul (KR)

(73) Assignee: KOREA INTERNET & SECURITY AGENCY, Seoul (KR)

(21) Appl. No.: 14/065,781

(22) Filed: Oct. 29, 2013

(30) Foreign Application Priority Data
Nov. 14, 2012 (KR) 10-2012-0128540

(51) Int. Cl. G06F 21/56

(52) U.S. Cl. CPC G06F 21/56
USPC 726/23

(57) ABSTRACT

Disclosed is a system for identifying malicious codes of high risk. The system includes a statistical data creation module for creating statistical data by collecting and processing malicious codes by channel, ranking, period, type, re-infection and vaccine diagnosis; a trend data creation module for creating trend data by processing the collected malicious codes by channel, field and type; a malicious code filtering module for extracting the malicious code of high risk from the collected malicious codes based on priority information including a URL type, the number of distribution sites, the number of landing sites, a vaccine diagnosis rate and the number of reports; and a database for processing and storing the statistical data, the trend data and the malicious codes of high risk in a form of a graph, a pie chart and a table.

### BACKGROUND OF THE INVENTION

1. Field of the Invention

The present invention relates to a system for identifying malicious codes of high risk, and more specifically, to a system for identifying malicious codes of high risk, which can promptly respond to a malicious code having a high destructive power by selectively classifying the malicious codes of high risk.

2. Background of the Related Art

As Internet services are diversified recently, the Internet use rate is increased, and since malicious codes such as computer viruses, Internet worms and the like are widely spread through the Internet, users are severely damaged by the malicious codes.

Particularly, the malicious codes are widely distributed through information such as a document file, a URL file, a Portable Executable (PE) file or the like frequently used by users.

Although vaccine programs are developed in order to detect such malicious codes, a system for collecting and systematically managing various types of malicious codes is required.

### SUMMARY OF THE INVENTION

Therefore, the present invention has been made in view of the above problems, and it is an object of the present invention to provide a system for identifying malicious codes of high risk, which assists a prompt response to the malicious codes of high risk by selectively classifying a malicious code having a high destructive power.

In addition, another object of the present invention is to provide a system for identifying malicious codes of high risk, which may grasp modifications and trends of malicious codes by monitoring malicious URLs and the malicious codes collected through a variety of channels.

The features of the present invention for accomplishing the objects of the present invention and performing characteristic functions of the present invention are as described below.

According to one aspect of the present invention, there is provided a system for identifying malicious codes of high risk, the system including: a statistical data creation module for creating statistical data by collecting and processing malicious codes by channel, ranking, period, type, re-infection and vaccine diagnosis; a trend data creation module for creating trend data by processing the collected malicious codes by channel, field and type; a malicious code filtering module for extracting the malicious code of high risk from the collected malicious codes based on priority information including a URL type, the number of distribution sites, the number of landing sites, a vaccine diagnosis rate and the number of reports; and a database for processing and storing the statistical data, the trend data and the malicious codes of high risk in a form of a graph, a pie chart and a table.

Here, the statistical data according to one aspect of the present invention may include statistical information of each channel divided into a web page, a user, an SNS and an e-mail.

In addition, the statistical data according to one aspect of the present invention may include statistical information of each ranking divided into a ranking of a malicious URL, the number of the malicious URL, the number of malicious URL distribution and landing sites, and a list of the distribution and landing sites.

In addition, the statistical data according to one aspect of the present invention may include statistical information of each re-infection divided into a range of re-infection, the number of malicious URL distribution and landing sites and a list of the distribution sites.

In addition, the statistical data according to one aspect of the present invention may include statistical information of each vaccine diagnosis divided into a range of diagnosis rate, the number of malicious codes (PE+documents), the number of malicious PE files, the number of malicious document files, and a PE+document list.

In addition, the trend data according to one aspect of the present invention may include trend information of each channel divided into a collection channel, previous collection of each week, month and year, latest collection of each week, month and year, previous collection, latest collection and a variation.

In addition, the trend data according to one aspect of the present invention may include trend information of each URL field divided into a URL field, previous collection of each week, month and year, latest collection of each week, month and year, previous collection, latest collection and a variation.

In addition, the trend data according to one aspect of the present invention may include trend information of each malicious code type divided into a malicious code type (PE, PDF, HWP, PPT, XLS and DOC), previous collection of each week, month and year, latest collection of each week, month and year, previous collection, latest collection and a variation.

### BRIEF DESCRIPTION OF THE DRAWINGS

FIG. 1 is a view showing the configuration of a system for identifying malicious codes of high risk 100 according to an embodiment of the present invention.

FIG. 2 is a view showing an example of processed statistical and trend data according to an embodiment of the present invention.

FIG. 3 is a view showing priority information in the form of a table according to an embodiment of the present invention.

### DESCRIPTION OF REFERENCE CHARACTERS

100: System for identifying malicious code of high risk
110: Statistical data creation module
120: Trend data creation module
130: Malicious code filtering module
140: Database

### DETAILED DESCRIPTION OF THE PREFERRED EMBODIMENT

The preferred embodiments of the present invention will be hereafter described in detail with reference to the accompanying drawings in order to easily embody the present invention by those skilled in the art. The like reference symbols denote like or similar functions throughout various aspects.

In the present invention, malicious codes are sorted in order of risk index based on risk factors (a flow-in URL, a diagnosis rate of a vaccine and the like) of a malicious code, and an object of the present invention is to classify the malicious codes. The system for identifying malicious codes of high risk according to the present invention selects and manages an urgent and highly destructive malicious code in response to a malicious code attack.

The object of the statistics and trends according to the present invention is to grasp modifications and tendency of malicious URLs and malicious codes by integrating and monitoring analysis information of the malicious URLs and the malicious codes from external systems.

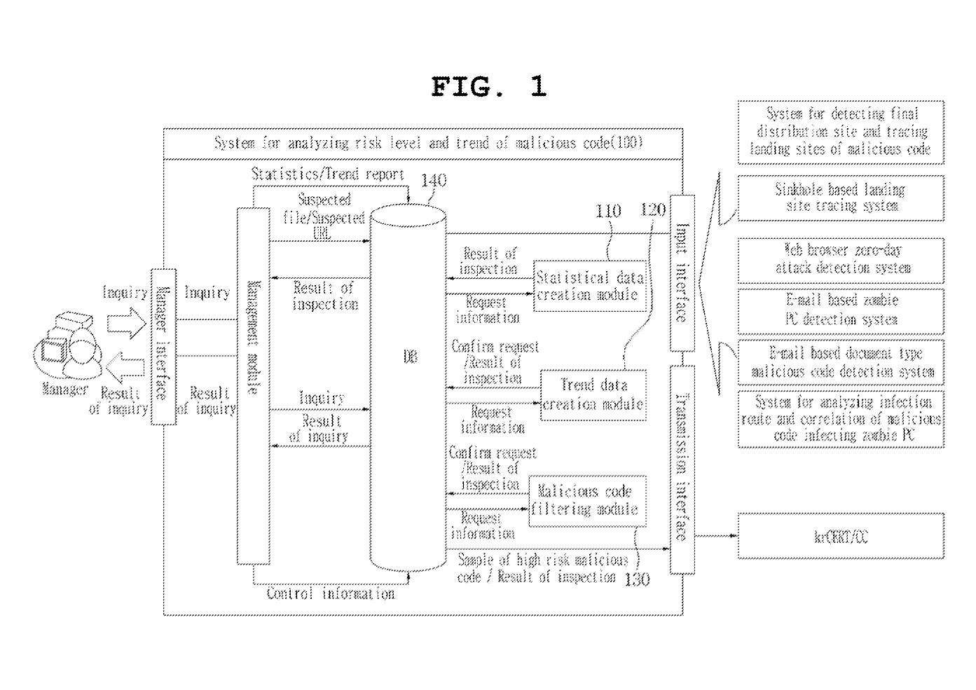

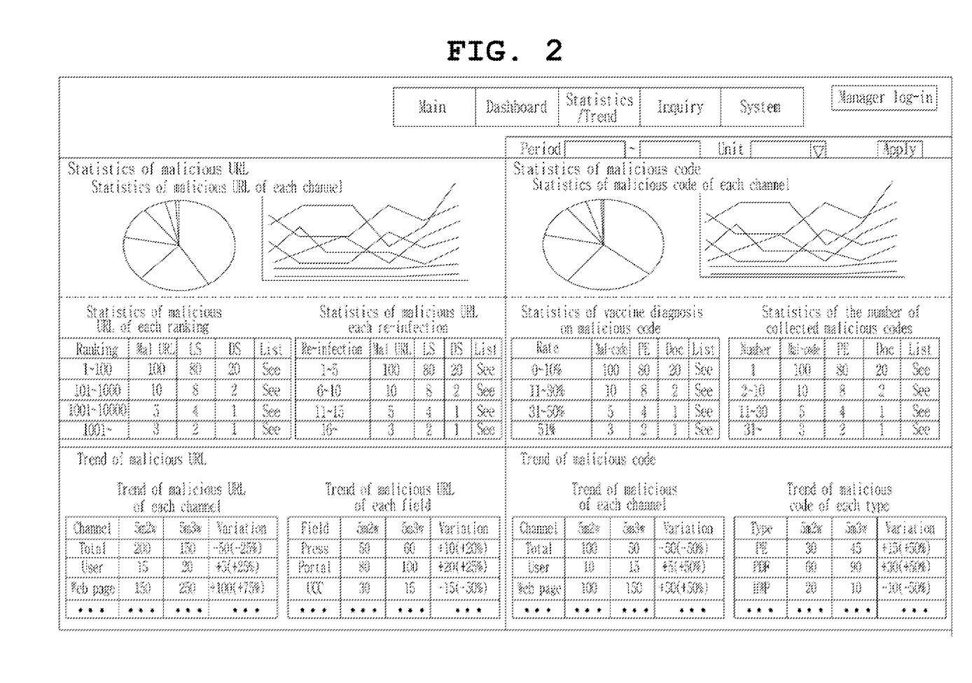

FIG. 1 is a view showing the configuration of a system for identifying malicious codes of high risk 100 according to an embodiment of the present invention, and FIG. 2 is a view showing an example of processed statistical and trend data according to an embodiment of the present invention.

As shown in FIG. 1, the system for identifying malicious codes of high risk 100 according to an embodiment of the present invention includes a statistical data creation module 110, a trend data creation module 120, a malicious code filtering module 130 and a database 140.

First, the statistical data creation module 110 according to the present invention creates statistical data by collecting and processing malicious codes by the channel, ranking, period, type, re-infection and vaccine diagnosis. The collected malicious codes are data related to PE, PDF, HWP, PPT, XLS and DOC files.

Here, the statistical data are data statistically processed on the items of channel, ranking, period, type, re-infection and vaccine diagnosis, including statistical information of each channel, statistical information of each ranking, statistical information of each re-infection and statistical information of each vaccine diagnosis.

The statistical information of each channel is divided into items including information on a web page, a user, an SNS and an e-mail, and the statistical information of each ranking is divided into items including information on the ranking of a malicious URL, the number of the malicious URL, the number of malicious URL distribution and landing sites, and a list of the distribution and landing sites. This may be expressed as shown in [Table 1].

TABLE 1
Statistical information of each ranking

| Items | Contents | Remarks |
|---|---|---|
| Ranking | Range of URL rankings | |
| Malicious URL | Number of malicious URLs | |
| | (Distribution sites + | |
| | Landing sites) | |
| Landing site | Number of landing sites | |
| Distribution site | Number of distribution | |
| | sites | |
| List | List of distribution sites + | Displayed as pop-up |
| | landing sites | window |

Contrarily, the statistical information of each re-infection may be divided into items including information on a range of re-infection, the number of malicious URL distribution and landing sites and a list of distribution sites, and the statistical information of each vaccine diagnosis may be divided into items including information on a range of diagnosis rate, the number of malicious codes (PE+documents), the number of malicious PE files, the number of malicious document files, and a PE+document list(malicious file list). The statistical information of each re-infection and the statistical information of each vaccine diagnosis may be respectively expressed as shown in [Table 2] and [Table 3].

TABLE 2
Statistical information of each re-infection

| Items | Contents | Remarks |
|---|---|---|
| Re-infection | Range of re-infection | |
| Malicious URL | Number of malicious URLs | |
| | (Distribution sites + Landing | |
| | sites) | |
| Landing site | Landing site | |
| Distribution | Distribution site | |
| site | | |
| List | List of landing sites + | Displayed as pop-up |
| | distribution sites | window |

TABLE 3
Statistical information of each vaccine diagnosis

| Items | Contents | Remarks |
|---|---|---|
| Diagnosis rate | Range of diagnosis rate | |
| Malicious code | Number of malicious | |
| | codes (PE + Documents) | |
| PE | Number of malicious PE | |
| | files | |
| Document | Number of malicious | |
| | document files | |
| List | PE + Document list | Displayed as pop-up |
| | | window |

As described above, if the statistical data of the malicious codes is classified by the channel, ranking, period, type, re-infection and vaccine diagnosis, a result thereof is expressed in the form of a pie chart, a graph and a table. Accordingly, a manager may easily understand the latest trend and flow of the malicious codes through the statistical data expressed in the form of a pie chart, a graph and a table as described above.

Next, the trend data creation module 120 according to the present invention creates trend data by processing the malicious codes, which are collected by the statistical data creation module 110 described above, by the channel, field and type.

Here, the trend data are data obtained by analyzing trends of items such as a channel, a field and a type and includes information on the trend of each channel, field and type.

The trend information of each channel of the trend data includes information on a collection channel, previous collection of each week, month and year, latest collection of each week, month and year, previous collection, latest collection and a variation, and the trend information of each field of the trend data includes information on a URL field, previous collection of each week, month and year, latest collection of each week, month and year, previous collection, latest collection and a variation. The trend information of each channel and the trend information of each field may be expressed as shown in [Table 4] and [Table 5].

TABLE 4
Information on trend of each channel

| Items | Contents | Remarks |
|---|---|---|
| Channel | Collection channel | |
| Previous period | Previous collection of | |
| | each week, month and | |
| | year | |
| Latest period | Latest collection of | |
| | each week, month and | |
| | year | |
| Statistics | Previous collection- | Displayed as pop-up |
| | Latest collection, | window |
| | Variation | |

TABLE 5
Information on trend of each field

| Items | Contents | Remarks |
|---|---|---|
| Field | URL field | |
| Previous period | Previous collection of | |
| | each week, month and | |
| | year | |
| Latest period | Latest collection of | |
| | each week, month and | |
| | year | |
| Variation | Previous collection- | Displayed aspop-up |
| | Latest collection, | window |
| | Variation | |

Contrarily, the trend information of each type of the trend data includes information on a malicious code type (PE, PDF, HWP, PPT, XLS and DOC), previous collection of each week, month and year, latest collection of each week, month and year, previous collection, latest collection and a variation. Such trend information of each type may be expressed as shown in [Table 6].

TABLE 6
Information on trend of each type

| Items | Contents | Remarks |
|---|---|---|
| Type | Malicious code type (PE, PDF, | |
| | DOC, HWO, PPT, XLS) | |
| Previous | Previous collection of each week, | |
| period | month and year | |
| Latest period | Latest collection of each week, | |
| | month and year | |
| Variation | Previous collection-Latest | Displayed as pop- |
| | collection, Variation | up window |

As described above, if malicious codes are processed by the channel, field and type and classified as trend data, they are expressed in the form of a pie chart, a graph and a table as shown in FIG. 2. Accordingly, a manager may easily respond to malicious codes by easily analyzing the trends of the malicious codes.

Next, the malicious code filtering module 130 according to the present invention extracts a malicious code of high risk from the malicious codes collected by the statistical data creation module 110 based on priority information including a URL type, the number of distribution sites, the number of landing sites, a vaccine diagnosis rate and the number of reports.

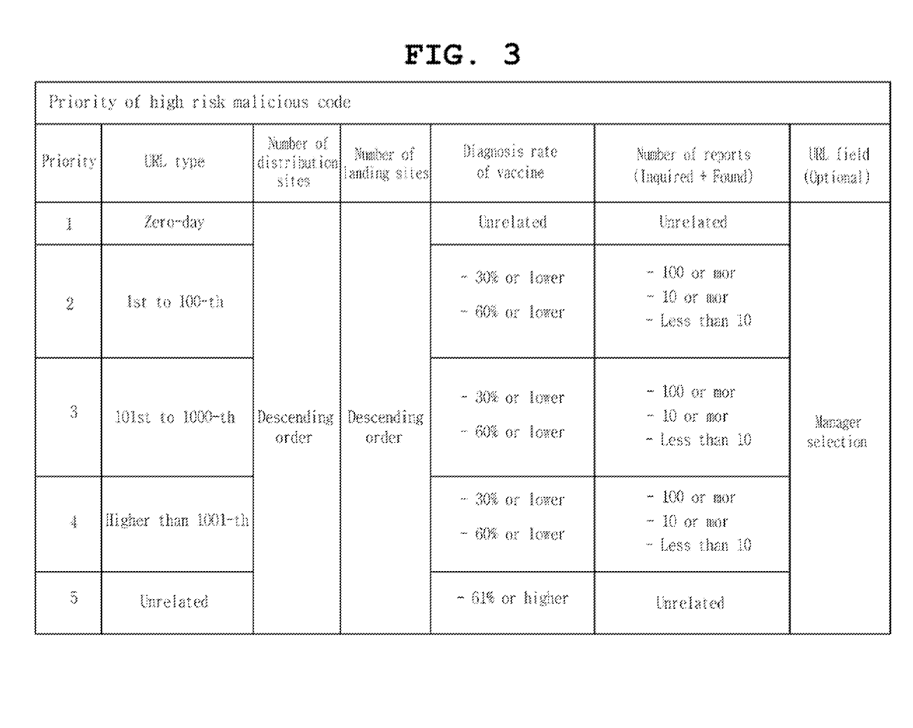

Here, the priority information may be expressed as shown in FIG. 3. FIG. 3 is a view showing priority information in the form of a table. In the priority information shown in FIG. 3, ‘zero day’ of the URL type is defined as a malicious code of high risk having a high priority, and a malicious code is defined as a malicious code of high risk having a high priority in descending order of the number of distribution sites and the number of landing sites. The ‘zero day’ malicious code is one of malicious codes which do not have a vaccine program or a responding or treatment measure, and the ‘zero day’ malicious code is risky since it is unknown or there is no way to respond although it is known.

In addition, a malicious code is classified as a malicious code of high risk by determining a priority within a range of each of the vaccine diagnosis rate and the number of reports. If a malicious code of high risk is extracted according to the priority, a manager may systematically and promptly respond to generation of the malicious code of high risk.

Finally, the database 140 according to the present invention stores the statistical data, the trend data and the malicious codes of high risk created by the modules 110, 120 and 130 described above, and processes and stores the data in the form of a graph, a pie chart and a table. A GUI module implementing the data in the form of a graph, a pie chart and a table is omitted.

In addition, as shown in FIG. 1, a management interface functioning as an interface between the manager and the database/modules and an input and transmission interface functioning as an interface with other systems may be provided. Since each of the interfaces is an indispensable factor for implementing a system, descriptions thereof are omitted.

As described above, according to the present invention, it is possible to systematically classify and identify malicious codes having a high destructive power, prevent diffusion of the malicious codes and enhance efficiency of detecting the malicious codes by processing and utilizing the malicious codes as trend data of each channel, field and type, creating statistical data by processing the malicious codes by the channel, ranking, period, type, re-infection and vaccine diagnosis, and creating trend data of malicious codes of a high risk group by processing the malicious codes by the channel, field and type.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for identifying malicious codes of high risk, the system comprising:
a statistical data creation module for creating statistical data by collecting and processing malicious codes by channel, ranking, period, type, re-infection and vaccine diagnosis;
a trend data creation module for creating trend data by processing the collected malicious codes by channel, field and type;
a malicious code filtering module for extracting the malicious code of high risk from the collected malicious codes based on priority information including a URL type, the number of distribution sites, the number of landing sites, a vaccine diagnosis rate and the number of reports; and
a database for processing and storing the statistical data, the trend data and the malicious codes of high risk in a form of a graph, a pie chart and a table.

2. The system according to claim 1, wherein the statistical data includes statistical information of each channel divided into a web page, a user, an SNS and an e-mail.

3. The system according to claim 1, wherein the statistical data includes statistical information of each ranking divided into a ranking of a malicious URL, the number of the malicious URL, the number of malicious URL distribution and landing sites, and a list of the distribution and landing sites.

4. The system according to claim 1, wherein the statistical data includes statistical information of each re-infection divided into a range of re-infection, the number of malicious URL distribution and landing sites and a list of the distribution sites.

5. The system according to claim 1, wherein the statistical data includes statistical information of each vaccine diagnosis divided into a range of diagnosis rate, the number of malicious codes (PE+documents), the number of malicious PE files, the number of malicious document files, and a PE+document list.

6. The system according to claim 1, wherein the trend data includes trend information of each channel divided into a collection channel, previous collection of each week, month and year, latest collection of each week, month and year, previous collection, latest collection and a variation.

7. The system according to claim 1, wherein the trend data includes trend information of each URL field divided into a URL field, previous collection of each week, month and year, latest collection of each week, month and year, previous collection, latest collection and a variation.

8. The system according to claim 1, wherein the trend data includes trend information of each malicious code type divided into a malicious code type (PE, PDF, HWP, PPT, XLS and DOC), previous collection of each week, month and year, latest collection of each week, month and year, previous collection, latest collection and a variation.
